(19) United States
(12) Patent Application Publication
(10) Pub. No.: US 2022/0014659 A1
(43) Pub. Date: Jan. 13, 2022

(54) ROTARY PHOTOGRAPHING METHOD, CONTROL DEVICE, MOBILE PLATFORM, AND STORAGE MEDIUM

(71) Applicant: SZ DJI TECHNOLOGY CO., LTD., Shenzhen (CN)

(72) Inventors: Wenshan LIAO, Shenzhen (CN); Pan HU, Shenzhen (CN)

(21) Appl. No.: 17/484,227

(22) Filed: Sep. 24, 2021

Related U.S. Application Data
(63) Continuation of application No. PCT/CN2019/079876, filed on Mar. 27, 2019.

(51) Int. Cl. H04N 5/235; H04N 17/00; G06T 5/00; G06T 5/50; G03B 17/56; G03B 15/00; B64D 47/08; B64C 39/02

(52) U.S. Cl. CPC H04N 5/2351; H04N 5/2352; H04N 17/002; G06T 5/006; G06T 5/50; B64C 2201/127; G03B 15/006; B64D 47/08; B64C 39/024; G06T 2207/10032; B64C 2201/027; G03B 17/561

(57) ABSTRACT

A rotary photographing method includes obtaining brightness information in a scene where a photographing target is located and a rotation mode of a gimbal that connects a photographing device to a mobile platform, and generating control information according to the brightness information and the rotation mode. The control information including rotation control information and exposure control information. The method further includes sending the rotation control information to the gimbal to control the gimbal to rotate according to the rotation control information to drive the photographing device to rotate, and sending the exposure control information to the photographing device to control the photographing device to perform exposure according to the exposure control information.

### CROSS-REFERENCE TO RELATED APPLICATION

This application is a continuation of International Application No. PCT/CN2019/079876, filed Mar. 27, 2019, the entire content of which is incorporated herein by reference.

### TECHNICAL FIELD

The present disclosure relates to the technical field of control technology and, more particularly, to a rotary photographing method, a mobile platform, and a machine readable storage medium.

### BACKGROUND

Currently, in an existing unmanned aerial vehicle aerial photography system, a photographing device can be arranged at a gimbal and rotate with the gimbal to complete photographing of a photo or a video. However, the existing unmanned aerial vehicle aerial photography system lacks a rotary photographing scheme, i.e., a scheme in which the photographing device can perform an exposure when the gimbal rotates, so that photographing experience is reduced.

### SUMMARY

In accordance with the disclosure, there is provided a rotary photographing method including obtaining brightness information in a scene where a photographing target is located and a rotation mode of a gimbal that connects a photographing device to a mobile platform, and generating control information according to the brightness information and the rotation mode. The control information including rotation control information and exposure control information. The method further includes sending the rotation control information to the gimbal to control the gimbal to rotate according to the rotation control information to drive the photographing device to rotate, and sending the exposure control information to the photographing device to control the photographing device to perform exposure according to the exposure control information.

Also in accordance with the disclosure, there is provided a control device of a mobile platform including a processor and a memory storing computer instructions that, when executed by the processor, cause the processor to obtain brightness information in a scene where a photographing target is located and a rotation mode of a gimbal that connects a photographing device to a mobile platform, and generate control information according to the brightness information and the rotation mode. The rotation control information and exposure control information. The computer instructions further cause the processor to send the rotation control information to the gimbal to control the gimbal to rotate according to the rotation control information to drive the photographing device to rotate, and send the exposure control information to the photographing device to control the photographing device to perform exposure according to the exposure control information.

Also in accordance with the disclosure, there is provided a mobile platform including a gimbal mounted with a photographing device and a control device including a processor and a memory. The memory stores computer instructions that, when executed by the processor, cause the processor to obtain brightness information in a scene where a photographing target is located and a rotation mode of a gimbal that connects a photographing device to a mobile platform, and generate control information according to the brightness information and the rotation mode. The rotation control information and exposure control information. The computer instructions further cause the processor to send the rotation control information to the gimbal to control the gimbal to rotate according to the rotation control information to drive the photographing device to rotate, and send the exposure control information to the photographing device to control the photographing device to perform exposure according to the exposure control information.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are only some embodiments of the present disclosure, and other drawings can be obtained from these drawings without any inventive effort for those of ordinary skill in the art.

FIG. 1 is a perspective view of a mobile platform according to an embodiment of the present disclosure.

FIG. 2 is a flow chart of a rotary photographing method according to an embodiment of the present disclosure.

FIG. 3 is a flow chart of another rotary photographing method according to an embodiment of the present disclosure.

FIG. 4 is a flow chart of generating control information according to an embodiment of the present disclosure.

FIG. 5 is a flow chart of determining number of exposures and parameters of each exposure according to an embodiment of the present disclosure.

FIG. 6 is a flow chart of determining whether an overexposure condition is met according to an embodiment of the present disclosure.

FIG. 7 is a flow chart of determining a sensitivity value of each exposure according to an embodiment of the present disclosure.

FIG. 8 is a flow chart of determining number of exposures and parameters of each exposure according to an embodiment of the present disclosure.

FIG. 9 is a flow chart of determining a sensitivity value of each exposure according to an embodiment of the present disclosure.

FIG. 10 is a schematic diagram showing a gimbal rotating at a mobile platform according to an embodiment of the present disclosure.

FIG. 11 is a flow chart of determining whether a photographing is successful according to an embodiment of the present disclosure.

FIG. 12 is a flow chart of determining whether a photographing is successful according to a gimbal end time and an exposure end time according to an embodiment of the present disclosure.

FIG. 13 is a flow chart of obtaining a synthesized image according to an embodiment of the present disclosure.

FIG. 14 is a flow chart of image brightness adjustment according to an embodiment of the present disclosure.

FIG. 15 is a flow chart of image geometry adjustment according to an embodiment of the present disclosure.

FIG. 16 is a schematic diagram of a circular space according to an embodiment of the present disclosure.

FIG. 17 is a schematic diagram of a control device of a mobile platform according to an embodiment of the present disclosure.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

The present disclosure provides a rotary photographing method. Consistent with the present disclosure, rotation control information and exposure control information can be generated according to brightness information in a scene where a photographing target is located and a rotation mode of the gimbal; and then the rotation control information is sent to the gimbal and the exposure control information is sent to the photographing device. In this way, the gimbal can drive the photographing device to rotate when rotating according to the rotation control information, and meanwhile, the photographing device can perform exposure according to the exposure control information, so that rotation of the gimbal and exposure of the photographing device can be performed at the same time, so as to achieve an effect of rotary photographing.

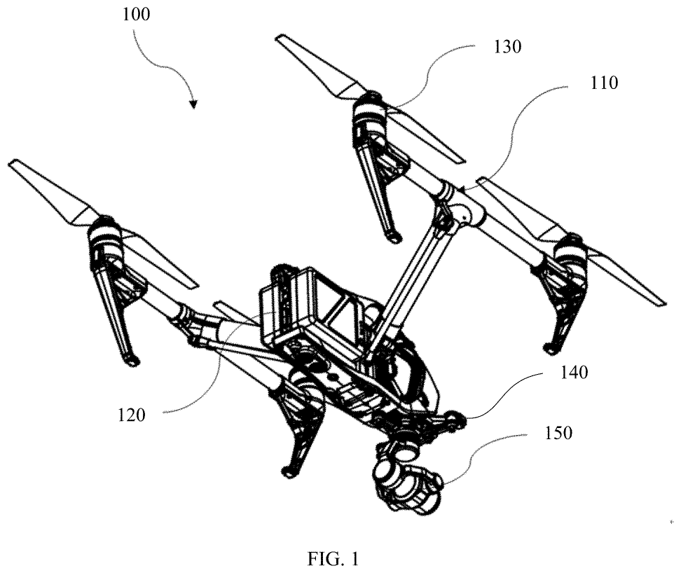

A rotary photographing method consistent with the present disclosure can be applied to a mobile platform provided by the present disclosure. FIG. 1 is a perspective view of the mobile platform according to an embodiment of the present disclosure. Referring to FIG. 1, a mobile platform 100 at least includes a body 110, a power supply battery 120 arranged at the body 110, a propulsion system 130, a gimbal 140, and a photographing device 150. The gimbal 140 is mounted with the photographing device 150. The mobile platform 100 also includes a memory (not shown in the figure) and a processor (not shown in the figure). The memory is connected to the processor through a communication bus and is configured to store computer instructions executable by the processor. The processor is connected to the gimbal 140 and the photographing device 150, and is configured to read the computer instructions from the memory to implement processes of the rotary photographing method.

In some embodiments, the mobile platform may include, but is not limited to, an aerial vehicle such as an unmanned aerial vehicle, a land vehicle such as an automobile, a water vehicle such as a ship, and another type of a motor vehicle. Those skilled in the art can make a selection according to a specific scene, which is not limited in the present disclosure.

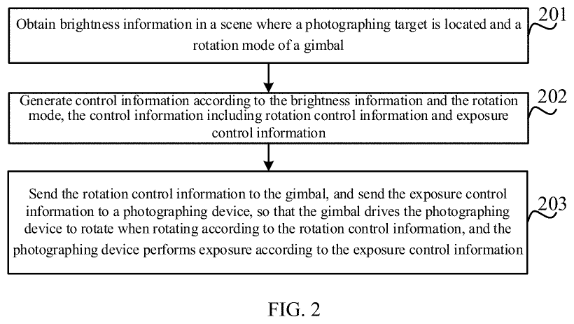

FIG. 2 is a flow chart of the rotary photographing method according to an embodiment of the present disclosure. Referring to FIG. 2, the rotary photographing method includes processes 201 to 203, which can be executed by the mobile platform, and specifically, can be executed by a control device of the mobile platform.

At 201, brightness information in a scene where a photographing target is located and a rotation mode of the gimbal are obtained.

In some embodiments, the photographing device at the mobile platform has a field of view (FOV), and the photographing device can obtain an image (a picture and/or a video) by photographing a scene within the field of view. In order to obtain a better photographing effect, the photographing device can first detect the brightness information in the scene where the photographing target is located before photographing, and then the photographing device can send the brightness information to the control device of the mobile platform via the communication bus (not shown in the figure).

In some embodiments, the control device of the mobile platform can obtain a rotation mode selected by a user through an interaction interface, thereby obtaining the rotation mode of the gimbal. The rotation mode may include at least one of a constant speed rotation mode, an acceleration rotation mode, or a deceleration rotation mode. In some embodiments, the gimbal rotates about a roll axis in each rotation mode. For example, a rotation range of the rotation about the roll axis is 0-360 degrees.

In some embodiments, the constant speed rotation mode refers to a mode in which the gimbal rotates at a constant speed according to a certain angular speed, such as 5 rad/s. The certain angular speed may be an angular speed preset by the user, or an angular speed determined according to different scenes, which is not limited in the present disclosure.

It can be understood that, when the gimbal is in the constant speed rotation mode, the photographing device can take images at a certain time interval or at different time intervals. The certain time interval may be a time interval preset by the user, or a time interval determined according to different scenes, which is not limited in the present disclosure.

In some other embodiments, the acceleration rotation mode refers to a mode in which the gimbal performs an angular speed acceleration rotation according to a certain angular acceleration (positive value). The certain angular acceleration may be an angular acceleration preset by the user, or an angular acceleration determined according to different scenes, which is not limited in the present disclosure.

It can be understood that, when the gimbal is in the acceleration rotation mode, the photographing device can take images at a certain time interval or at different time intervals. The certain time interval and the different time intervals may be time intervals preset by the user, or time intervals determined according to different scenes, which is not limited in the present disclosure.

In some other embodiments, the deceleration rotation mode refers to a mode in which the gimbal performs an angular speed deceleration rotation according to a certain angular acceleration (negative value). The certain angular acceleration may be an angular acceleration preset by the user, or an angular acceleration determined according to different scenes, which is not limited in the present disclosure.

It can be understood that, when the gimbal is in the deceleration rotation mode, the photographing device can take images at a certain time interval or at different time intervals. The certain time interval and the different time intervals may be time intervals preset by the user, or time intervals determined according to different scenes, which is not limited in the present disclosure.

In some other embodiments, the gimbal can also be in a variable speed rotation mode, where the variable speed rotation mode can be a rotation with acceleration first and then deceleration, a rotation with deceleration first and then acceleration, or a combination of deceleration rotation, acceleration rotation, and constant speed rotation. A suitable combination can be selected according to a specific scene, and a corresponding scheme falls within the scope of the present disclosure, provided that a corresponding photographing effect can be achieved.

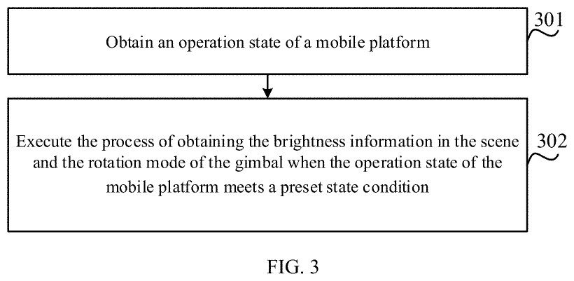

It should be noted that, in order to ensure that the photographing device is in the same state condition during each exposure, state condition of the mobile platform also needs to be determined in some embodiments. Referring to FIG. 3, an operation state of the mobile platform is obtained (corresponding to process 301), and it is determined whether the operation state of the mobile platform meets a preset state condition. When the operation state of the mobile platform meets the preset state condition, the process of obtaining the brightness information in the scene and the rotation mode of the gimbal is executed (corresponding to process 302).

In an example where the mobile platform is an unmanned aerial vehicle, the preset state condition may include that the mobile platform is in a hovering state. In some embodiments, the unmanned aerial vehicle can determine whether itself is in the hovering state. When the unmanned aerial vehicle is in the hovering state, the brightness information in the scene and the rotation mode of the gimbal are obtained to perform rotary photographing; when the mobile platform is not in the hovering state, the user is prompted to hover the unmanned aerial vehicle through a user interaction interface. It is predetermined that the mobile platform is in the hovering state, so that stability of the photographing device when performing the rotary photographing can be ensured, and the effect of rotary photographing is improved.

At 202, control information is generated according to the brightness information and the rotation mode, the control information including rotation control information and exposure control information.

In some embodiments, the control information may be generated according to the brightness information provided by the photographing device and the rotation mode of the gimbal, and the control information may include the rotation control information and the exposure control information. The rotation control information is configured to control the rotation of the gimbal to drive the photographing device to rotate, and the exposure control information is configured to control the photographing device to perform exposure.

In some embodiments, generating the control information according to the brightness information and the rotation mode may include the following processes.

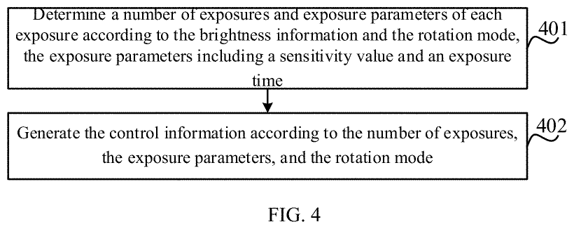

In some embodiments, referring to FIG. 4, number of exposures and exposure parameters of each exposure are determined according to the brightness information and the rotation mode, the exposure parameters including a sensitivity (ISO) value and an exposure time (corresponding to process 401). Then, the control information is generated according to the number of exposures, the exposure parameters, and the rotation mode (corresponding to process 402). For example, the rotation control information can be generated according to the rotation mode, and the rotation control information is configured to control the gimbal to rotate according to the rotation mode, and meanwhile, the exposure control information is configured to control the photographing device to perform exposure. The exposure control information can be configured to adjust at least one parameter of a sensitivity value, a shutter speed, or an aperture of the photographing device, so as to achieve an effect of controlling the photographing device to perform exposure.

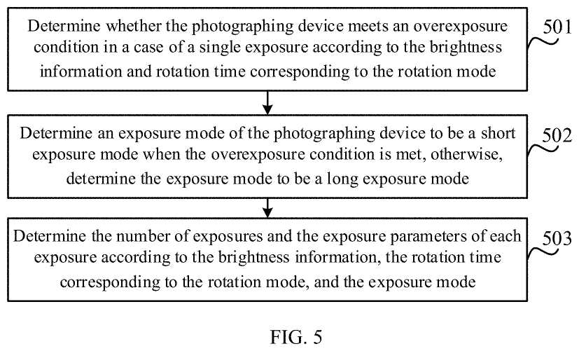

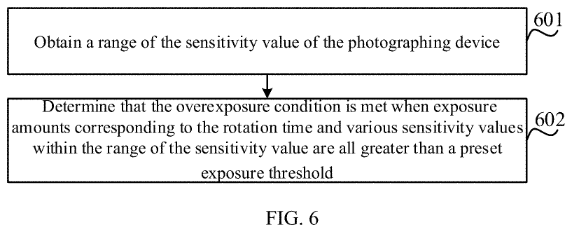

In some embodiments, obtaining the number of exposures and the exposure parameters of each exposure may include, referring to FIG. 5, according to the brightness information and rotation time corresponding to the rotation mode, determining whether the photographing device meets an overexposure condition in a case of a single exposure (corresponding to process 501). Determining whether the overexposure condition is met includes, referring to FIG. 6, obtaining a range of the sensitivity value of the photographing device (corresponding to process 601). When exposure amounts corresponding to the rotation time and various sensitivity values within the range of the sensitivity value are all greater than a preset exposure threshold, it is determined that the overexposure condition is met (corresponding to process 602).

Referring to FIG. 5 again, when the overexposure condition is met, an exposure mode of the photographing device is determined to be a short exposure mode, otherwise, the exposure mode is determined to be a long exposure mode (corresponding to process 502). Then, the number of exposures and the exposure parameters of each exposure are determined according to the brightness information, the rotation time corresponding to the rotation mode, and the exposure mode (corresponding to process 503).

In some embodiments, determining the number of exposures and the exposure parameters may include the following processes.

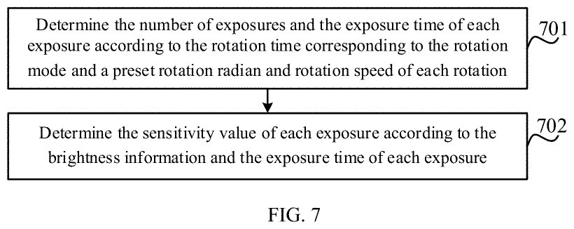

In some embodiments, when the exposure mode is the short exposure mode, referring to FIG. 7, the number of exposures and the exposure time of each exposure is determined according to the rotation time corresponding to the rotation mode and a preset rotation radian and rotation speed of each rotation (corresponding to process 701). Then, the sensitivity value of each exposure is determined according to the brightness information and the exposure time of each exposure (corresponding to process 702).

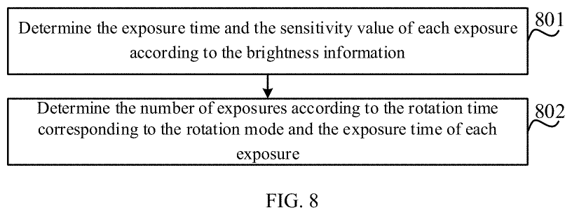

In some other embodiments, when the exposure mode is the short exposure mode, referring to FIG. 8, the exposure time and the sensitivity value of each exposure are determined according to the brightness information (corresponding to process 801). Then, the number of exposures is determined according to the rotation time corresponding to the rotation mode and the exposure time of each exposure (corresponding to process 802).

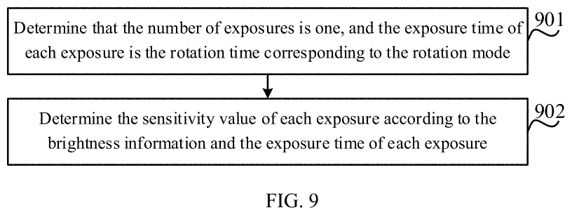

In some other embodiments, when the exposure mode is the long exposure mode, referring to FIG. 9, after it is determined that the number of exposures is one, the exposure time of each exposure can be determined to be the rotation time corresponding to the rotation mode (corresponding to process 901). Then, the sensitivity value of each exposure is determined according to the brightness information and the exposure time of each exposure (corresponding to process 902).

It should be noted that for the photographing device with the same exposure value (EV), if the aperture is unchanged, the higher the sensitivity value, the faster the shutter speed, that is, the shorter the exposure time of each exposure; or, if the shutter speed is unchanged, the higher the sensitivity value, the smaller the aperture. In some embodiments, the aperture of the photographing device is a fixed value, so the exposure parameters may be the sensitivity value and the exposure time of each exposure. In some other embodiments, when the aperture of the photographing device is not a fixed value, the exposure parameters may be the sensitivity value, the aperture, and the exposure time for each exposure. Those skilled in the art can adjust the exposure parameters according to a specific scene, and a corresponding scheme falls within the scope of the present disclosure.

The long exposure mode in the embodiments described above is suitable for a scene with low brightness, while the short exposure mode is suitable for a scene with high brightness or large brightness change (i.e., high dynamic range). Those skilled in the art can select a corresponding exposure mode according to a specific scene, which is not limited herein.

At 203, the rotation control information is sent to the gimbal, and the exposure control information is sent to the photographing device, so that the gimbal drives the photographing device to rotate when rotating according to the rotation control information, and the photographing device performs exposure according to the exposure control information.

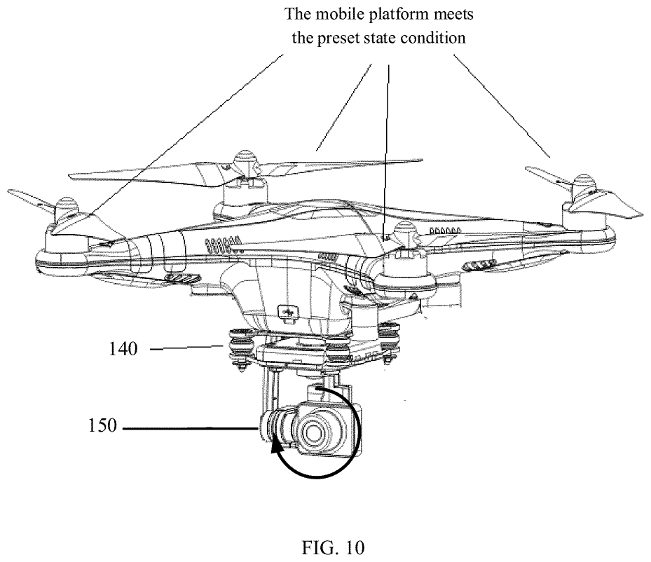

In some embodiments, after receiving the rotation control information, the gimbal drives the photographing device to rotate when rotating according to the rotation mode. As shown in FIG. 10, the gimbal can rotate about the roll axis, and for example, the rotation range of the rotation about the roll axis is 0-360 degrees. While the gimbal is rotating, the photographing device is exposed at the same time. After the exposure of the photographing device is completed, it can also be determined whether the photographing is successful, which includes the following processes.

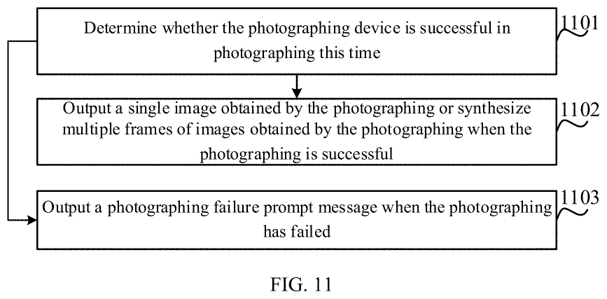

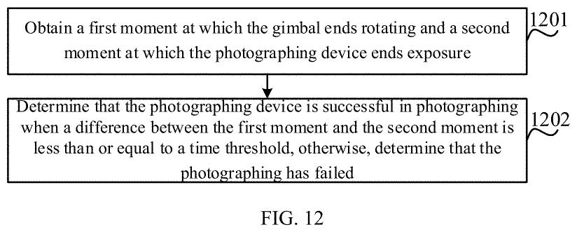

Referring to FIG. 11, it is determined whether the photographing device is successful in photographing this time (corresponding to process 1101). The following processes are used to determine whether the photographing is successful. Referring to FIG. 12, obtaining a first moment at which the gimbal ends rotating and a second moment at which the photographing device ends exposure (corresponding to process 1201). When a difference between the first moment and the second moment is less than or equal to a time threshold, it is determined that the photographing device is successful in photographing, otherwise, it is determined that the photographing has failed (corresponding to process 1202).

Refer to FIG. 11 again, when the photographing is successful, a single image obtained by the photographing is output or multiple images obtained by the photographing are synthesized (corresponding to process 1102). When the photographing has failed, a photographing failure prompt message is output (corresponding to process 1103).

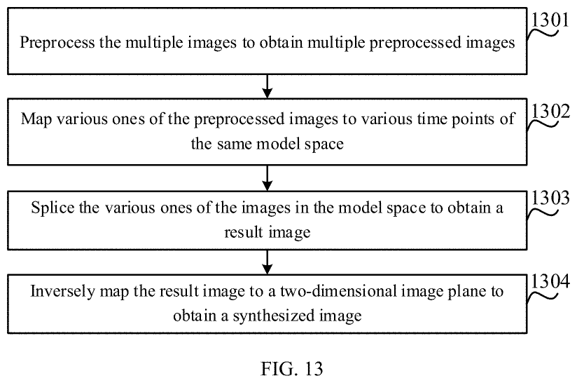

In some embodiments, the multiple images may be synthesized. Referring to FIG. 13, the multiple images are preprocessed to obtain multiple preprocessed images (corresponding to process 1301). The preprocessing may include image brightness processing and/or image geometry processing.

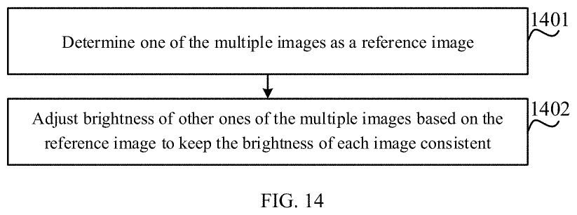

In an example of the image brightness processing, referring to FIG. 14, one image of the multiple images is determined as a reference image (corresponding to process 1401). Then, brightness of other images are adjusted based on the reference image to keep the brightness of each image consistent (corresponding to process 1402). Since brightness of the scene where the photographing target is located may change during the photographing, adjusting the brightness of each image is beneficial to improve quality of subsequent image synthesis.

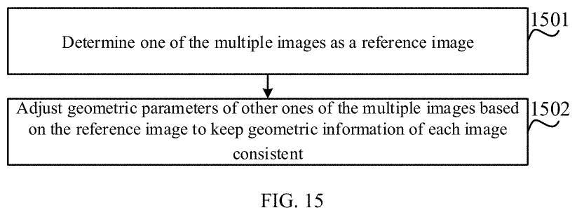

In an example of the image geometry processing, referring to FIG. 15, one image in the multiple images is determined as a reference image (corresponding to process 1501). Then, geometric parameters of other images are adjusted based on the reference image to keep geometric information of each image consistent (corresponding to process 1502). In some embodiments, through adjustment of the geometric parameters of each image, the multiple images photographed by the photographing device can have the same center point, so that a problem that the center points of different images are staggered caused by an unstable motion state of the mobile platform can be corrected, which is conducive to improving accuracy of the subsequent image synthesis. In some embodiments, through adjustment of the geometric parameters of each image, focal planes of the multiple images photographed by the photographing device can be parallel, so that a problem that the focal planes of different images are non-parallel caused by the unstable motion state of the mobile platform can be corrected, which is conducive to improving the accuracy of the subsequent image synthesis.

It should be noted that, in view of quality of the photographed image, another image quality adjustment operation such as quality increase processing may also be performed on the image, so as to improve effect of the subsequent image synthesis. In some other embodiments, those skilled in the art can also select a suitable preprocessing mode according to a specific scene, and a corresponding scheme falls within the scope of the present disclosure.

In some embodiments, the photographing failure prompt message can be popped out in a form of a text file, flashed on a display screen, or voiced, so that the user can be prompted quickly and accurately, which is convenient for the user to continue photographing.

Referring to FIG. 13 again, various ones of preprocessed images are mapped to various time points of the same model space (corresponding to process 1302). For example, during the rotary photographing, a scene photographed by the photographing device forms a circular space centered on the photographing device, so that various images can be sequentially mapped to time points of the circular space according to photographing time at 1302. Mapping operations include expansion, scaling, and rotation, that is, expanding the image, scaling each part of the image to turn the image into a fan shape, and rotating a certain angle to fill the circular space. After that, the various images are spliced in the model space to obtain a result image (corresponding to process 1303). Finally, the result image is inversely mapped to a two-dimensional image plane to obtain a synthesized image (corresponding to process 1304).

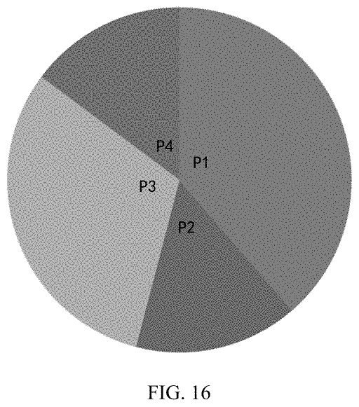

In an example of the photographing device shown in FIG. 10, images P1, P2, P3, and P4 can be obtained through the rotary photographing of the photographing device, and fan-shaped images can be obtained through expanding and scaling, which are then rotated by corresponding angles to be mapped to the circular space as shown in FIG. 16.

For example, assuming that a total of N images are photographed, a rotation angle of the nth (n≤N) image can be calculated according to the following formula:

θ=τ/t₀×360°

τ is the photographing time of the nth image, t₀ is a total photographing duration, and θ is the rotation angle. For example, assuming that the total photographing duration is 60 s, and the photographing time corresponding to the first image obtained in the first exposure is 0 s, then the rotation angle corresponding to the first image is 0 degrees; the photographing time corresponding to the second image obtained in the second exposure is 20 s, then the rotation angle corresponding to the second image is 120 degrees; the photographing time corresponding to the third image obtained in the third exposure is 35 s, then the rotation angle corresponding to the third image is 210 degrees; the photographing time corresponding to the fourth image obtained in the fourth exposure is 50 s, then the rotation angle corresponding to the fourth image is 300 degrees.

For example, areas of the various ones of fan-shaped images are related to rotation speed of the gimbal. For example, in the constant speed rotation mode, the areas of the various fan-shaped images are the same; as another example, in the acceleration rotation mode, the areas of the various fan-shaped images gradually become larger (or smaller) in a clockwise direction; as another example, in the deceleration rotation mode, areas of the various fan-shaped images gradually become smaller (or larger) in the clockwise direction.

Thus, in the embodiments of the present disclosure, the brightness information in the scene where the photographing target is located and the rotation mode of the gimbal can be obtained; then, the control information is generated according to the brightness information and the rotation mode, the control information including the rotation control information and the exposure control information; after that, the rotation control information is sent to the gimbal and the exposure control information is sent to the photographing device, so that the gimbal can drive the photographing device to rotate when rotating according to the rotation control information, and meanwhile, the photographing device can perform exposure. In the embodiments of the present disclosure, the photographing device is controlled to perform exposure while the gimbal is controlled to rotate, so that the effect of rotary photographing is achieved, and the photographing experience is improved.

The present disclosure also provides a rotary photographing method, which can also be applied to the mobile platform shown in FIG. 1. The difference from the method shown in FIG. 2 is that, after the rotation control information is generated, the rotation control information is sent to a propulsion system of the mobile platform. The propulsion system calculates the rotation control information and then controls rotation of the mobile platform to replace the rotation of the gimbal, and the photographing device performs exposure during the rotation. The above scheme can also solve corresponding technical problems and achieve corresponding technical effects.

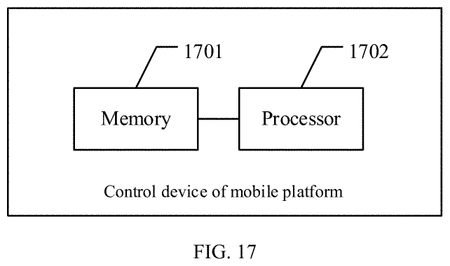

Referring to FIG. 17, which is a schematic diagram of the control device of the mobile platform according to an embodiment of the present disclosure. Specifically, the mobile platform is mounted with the photographing device through the gimbal, and the control device includes a memory 1701 and a processor 1702. The memory 1701 is connected to the processor 1702 through a communication bus and is configured to store computer instructions executable by the processor 1702. The processor 1702 is configured to read the computer instructions from the memory 1701, and execute the following processes: obtaining brightness information in a scene where a photographing target is located and a rotation mode of the gimbal; generating control information according to the brightness information and the rotation mode, the control information including rotation control information and exposure control information; sending the rotation control information to the gimbal, and sending the exposure control information to the photographing device, so that the gimbal drives the photographing device to rotate when rotating according to the rotation control information, and the photographing device performs exposure according to the exposure control information.

Further, the brightness information is detected by the photographing device.

Further, the rotation mode includes at least one of a constant speed rotation mode, an acceleration rotation mode, or a deceleration rotation mode.

Further, the gimbal rotates about a roll axis in the rotation mode.

Further, a rotation range of the rotation about the roll axis is 0-360 degrees.

Further, the processor 1702 is configured to read the computer instructions from the memory, and specifically execute the following processes: determining number of exposures and exposure parameters of each exposure according to the brightness information and the rotation mode, the exposure parameters including a sensitivity value and an exposure time; generating the control information according to the number of exposures, the exposure parameters, and the rotation mode.

Further, the processor 1702 is configured to read the computer instructions from the memory, and specifically execute the following processes: determining whether the photographing device meets an overexposure condition in a case of a single exposure according to the brightness information and rotation time corresponding to the rotation mode; determining an exposure mode of the photographing device to be a short exposure mode when the overexposure condition is met, otherwise, determining the exposure mode to be a long exposure mode; determining the number of exposures and the exposure parameters of each exposure according to the brightness information, the rotation time corresponding to the rotation mode, and the exposure mode.

Further, when the exposure mode is the short exposure mode, the processor 1702 is configured to read the computer instructions from the memory, and specifically execute the following processes: determining the number of exposures and the exposure time of each exposure according to the rotation time corresponding to the rotation mode and a preset rotation radian and rotation speed of each rotation; determining the sensitivity value of each exposure according to the brightness information and the exposure time of each exposure.

Further, when the exposure mode is the short exposure mode, the processor 1702 is configured to read the computer instructions from the memory, and specifically execute the following processes: determining the exposure time and the sensitivity value of each exposure according to the brightness information; determining the number of exposures according to the rotation time corresponding to the rotation mode and the exposure time of each exposure.

Further, when the exposure mode is the long exposure mode, the processor 1702 is configured to read the computer instructions from the memory, and specifically execute the following processes: determining that the number of exposures is one, and the exposure time of each exposure is the rotation time corresponding to the rotation mode; determining the sensitivity value of each exposure according to the brightness information and the exposure time of each exposure.

Further, the processor 1702 is configured to read the computer instructions from the memory, and specifically execute the following processes: obtaining a range of the sensitivity value of the photographing device; determining that the overexposure condition is met when exposure amounts corresponding to the rotation time and various sensitivity values within the range of the sensitivity value are all greater than a preset exposure threshold.

Further, the processor 1702 is configured to read the computer instructions from the memory, and further execute the following processes: determining whether the photographing device is successful in photographing this time; outputting a single image obtained by the photographing or synthesizing multiple images obtained by the photographing when the photographing is successful; outputting a photographing failure prompt message when the photographing has failed.

Further, the processor 1702 is configured to read the computer instructions from the memory, and specifically execute the following processes: obtaining a first moment at which the gimbal ends rotating and a second moment at which the photographing device ends exposure; determining that the photographing device is successful in photographing when a difference between the first moment and the second moment is less than or equal to a time threshold, otherwise, determining that the photographing has failed.

Further, the processor 1702 is configured to read the computer instructions from the memory, and further execute the following processes: preprocessing the multiple images to obtain multiple preprocessed images; mapping various ones of preprocessed images to various time points of the same model space; splicing the various images in the model space to obtain a result image; inversely mapping the result image to a two-dimensional image plane to obtain a synthesized image.

Further, the processor 1702 is configured to read the computer instructions from the memory, and specifically execute the following processes: determining one image in the multiple images as a reference image; adjusting brightness of other images based on the reference image to keep the brightness of each image consistent.

Further, the processor 1702 is configured to read the computer instructions from the memory, and specifically execute the following processes: determining one image in the multiple images as a reference image; adjusting geometric parameters of other images based on the reference image to keep geometric information of each image consistent.

Further, the processor 1702 is configured to read the computer instructions from the memory, and further execute the following processes: obtaining an operation state of the mobile platform; executing the process of obtaining the brightness information in the scene and the rotation mode of the gimbal when the operation state of the mobile platform meets a preset state condition, the preset state condition including that the mobile platform is in a hovering state.

The memory 1701 may include a volatile memory, a non-volatile memory, or a combination of memories of different types described above. The processor 1702 may be a central processing unit (CPU), and may further include a hardware chip such as an application-specific integrated circuit (ASIC), a programmable logic device (PLD), or a combination thereof. The PLD may be a complex programmable logic device (CPLD), a field-programmable gate array (FPGA), or any combination thereof.

According to the control device of the mobile platform provided by the embodiments of the present disclosure, the brightness information in the scene where the photographing target is located and the rotation mode of the gimbal can be obtained; then, the control information is generated according to the brightness information and the rotation mode, the control information including the rotation control information and the exposure control information; after that, the rotation control information is sent to the gimbal, and the exposure control information is sent to the photographing device, so that the gimbal can drive the photographing device to rotate when rotating according to the rotation control information, and the photographing device can perform exposure according to the exposure control information. In the embodiments of the present disclosure, the photographing device is controlled to perform exposure while the gimbal is controlled to rotate, so that the effect of rotary photographing is achieved, and the photographing experience is improved.

The embodiments of the present disclosure also provide a mobile platform, which includes a gimbal mounted with a photographing device, and a control device of the mobile platform described above.

The embodiments of the present disclosure also provide a machine readable storage medium which stores machine readable instructions, and when the machine readable instructions are executed, processes of the method consistent with the present disclosure, such as the example method described above in connection with FIGS. 2-15 are implemented.

It should be noted that relational terms such as first and second are only used herein to distinguish one entity or operation from another entity or operation, and do not necessarily require or imply any such actual relationship or order between these entities or operations. The terms “include,” “involve” or any other variations thereof are intended to cover non-exclusive inclusion, so that a process, method, object, or device including a series of elements not only includes those elements, but also includes other elements that are not explicitly listed, or also includes elements inherent to such processes, method, object, or device. Without further restrictions, the element associated with phrase “including a . . . ” does not exclude the existence of other identical elements in the process, method, object, or device that includes the element.

The above are detailed description of a detection device and method provided by the present disclosure. Some examples are used in this specification to illustrate the principles and embodiments of the present disclosure. The description of the embodiments is for the purpose of helping to understand the method of this disclosure and its core idea. For those of ordinary skill in the art, there will be changes in specific embodiments and application scope according to the idea of this disclosure. In summary, the content of this specification should not be understood as a limitation of the present disclosure.

What is claimed is:

1. A rotary photographing method comprising:
obtaining brightness information in a scene where a photographing target is located and a rotation mode of a gimbal that connects a photographing device to a mobile platform;
generating control information according to the brightness information and the rotation mode, the control information including rotation control information and exposure control information;
sending the rotation control information to the gimbal to control the gimbal to rotate according to the rotation control information to drive the photographing device to rotate; and
sending the exposure control information to the photographing device to control the photographing device to perform exposure according to the exposure control information.

2. The rotary photographing method of claim 1, wherein the brightness information is detected by the photographing device.

3. The rotary photographing method of claim 1, wherein the rotation mode includes at least one of a constant speed rotation mode, an acceleration rotation mode, or a deceleration rotation mode.

4. The rotary photographing method of claim 1, wherein the gimbal is configured to rotate about a roll axis in the rotation mode.

5. The rotary photographing method of claim 4, wherein a rotation range of the rotation about the roll axis is 0-360 degrees.

6. The rotary photographing method of claim 1, wherein generating the control information according to the brightness information and the rotation mode includes:
determining a number of exposures and exposure parameters of each exposure according to the brightness information and the rotation mode, the exposure parameters including a sensitivity value and an exposure time; and
generating the control information according to the number of exposures, the exposure parameters, and the rotation mode.

7. The rotary photographing method of claim 6, wherein determining the number of exposures and the exposure parameters of each exposure according to the brightness information and the rotation mode includes:
determining whether the photographing device meets an overexposure condition in a case of a single exposure according to the brightness information and a rotation time corresponding to the rotation mode;
determining an exposure mode of the photographing device to be a short exposure mode in response to determining that the overexposure condition is met;
determining the exposure mode to be a long exposure mode in response to determining that the overexposure condition is not met; and
determining the number of exposures and the exposure parameters of each exposure according to the brightness information, the rotation time corresponding to the rotation mode, and the exposure mode.

8. The rotary photographing method of claim 7, wherein:
the exposure mode is the short exposure mode; and
determining the number of exposures and the exposure parameters of each exposure according to the brightness information, the rotation time corresponding to the rotation mode, and the exposure mode includes:
determining the number of exposures and the exposure time of each exposure according to the rotation time corresponding to the rotation mode and a preset rotation radian and a rotation speed of each rotation; and
determining the sensitivity value of each exposure according to the brightness information and the exposure time of each exposure.

9. The rotary photographing method of claim 7, wherein:
the exposure mode is the short exposure mode; and
determining the number of exposures and the exposure parameters of each exposure according to the brightness information, the rotation time corresponding to the rotation mode, and the exposure mode includes:
determining the exposure time and the sensitivity value of each exposure according to the brightness information; and
determining the number of exposures according to the rotation time corresponding to the rotation mode and the exposure time of each exposure.

10. The rotary photographing method of claim 7, wherein:
the exposure mode is the long exposure mode; and
determining the number of exposures and the exposure parameters of each exposure according to the brightness information, the rotation time corresponding to the rotation mode, and the exposure mode includes:
determining that the number of exposures equals one, and the exposure time of each exposure is the rotation time corresponding to the rotation mode; and
determining the sensitivity value of each exposure according to the brightness information and the exposure time of each exposure.

11. The rotary photographing method of claim 7, wherein determining whether the photographing device meets the overexposure condition in the case of the single exposure according to the brightness information and the rotation time corresponding to the rotation mode includes:
obtaining a range of the sensitivity value of the photographing device; and
determining that the overexposure condition is met in response to exposure amounts corresponding to the rotation time and various sensitivity values within the range of the sensitivity value being greater than a preset exposure threshold.

12. The rotary photographing method of claim 1, further comprising:
determining whether photographing of the photographing device is successful;
outputting a single image obtained by the photographing or synthesizing a plurality of images obtained by the photographing in response to determining the photographing is successful; and
outputting a photographing failure prompt message in response to determining the photographing has failed.

13. The rotary photographing method of claim 12, wherein determining whether the photographing is successful includes:
obtaining a first moment at which the gimbal ends rotating and a second moment at which the photographing device ends exposure;
determining that the photographing is successful in response to a difference between the first moment and the second moment being less than or equal to a time threshold, otherwise, determining that the photographing has failed.

14. The rotary photographing method of claim 1, further comprising:
performing preprocessing on a plurality of images captured by the photographing device to obtain a plurality of preprocessed images;
mapping of the plurality of preprocessed images to various time points of a same model space;
splicing the plurality of images in the model space to obtain a result image; and
inversely mapping the result image to a two-dimensional image plane to obtain a synthesized image.

15. The rotary photographing method of claim 14, wherein performing the preprocessing on the plurality of multiple images includes:
determining one of the plurality of images as a reference image; and
adjusting brightness of other ones of the plurality of images based on the reference image to keep the brightness consistent across the plurality of images.

16. The rotary photographing method of claim 14, wherein performing the preprocessing on the plurality of images includes:
determining one of the plurality of images as a reference image; and
adjusting geometric parameters of other ones of the plurality of images based on the reference image to keep geometric information consistent across the plurality of images.

17. The rotary photographing method of claim 1, further comprising, before obtaining the brightness information in the scene and the rotation mode of the gimbal:
obtaining an operation state of the mobile platform; and
wherein obtaining the brightness information in the scene and the rotation mode of the gimbal includes obtaining the brightness information in the scene and the rotation mode of the gimbal in response to the operation state of the mobile platform meeting a preset state condition, the preset state condition including that the mobile platform is in a hovering state.

18. A control device of a mobile platform comprising:
a processor; and
a memory storing computer instructions that, when executed by the processor, cause the processor to:
obtain brightness information in a scene where a photographing target is located and a rotation mode of a gimbal that connects a photographing device to the mobile platform;
generate control information according to the brightness information and the rotation mode, the control information including rotation control information and exposure control information;
send the rotation control information to the gimbal to control the gimbal to rotate according to the rotation control information to drive the photographing device to rotate; and
send the exposure control information to the photographing device to control the photographing device to perform exposure according to the exposure control information.

19. The control device of claim 18, wherein the gimbal is configured to rotate about a roll axis in the rotation mode.

20. A mobile platform comprising:
a gimbal mounted with a photographing device; and
a control device including:
a processor; and
a memory storing computer instructions that, when executed by the processor, cause the processor to:
obtain brightness information in a scene where a photographing target is located and a rotation mode of a gimbal that connects a photographing device to the mobile platform;
generate control information according to the brightness information and the rotation mode, the control information including rotation control information and exposure control information;
send the rotation control information to the gimbal to control the gimbal to rotate according to the rotation control information to drive the photographing device to rotate; and
send the exposure control information to the photographing device to control the photographing device to perform exposure according to the exposure control information.
